(19) United States
(12) Patent Application Publication
(10) Pub. No.: US 2017/0135019 A1
(43) Pub. Date: May 11, 2017

(54) CONTEXT AWARE WIRELESS LOCAL AREA NETWORK CONNECTION

(71) Applicant: QUALCOMM Incorporated, San Diego, CA (US)

(72) Inventors: Santosh VAMARAJU, San Jose, CA (US); Carlos Horacio ALDANA, Mountain View, CA (US)

(21) Appl. No.: 15/344,925

(22) Filed: Nov. 7, 2016

Related U.S. Application Data
(60) Provisional application No. 62/252,551, filed on Nov. 8, 2015.

(51) Int. Cl. H04W 36/30; H04W 36/00; H04B 17/318

(52) U.S. Cl. CPC H04W 36/30; H04B 17/318; H04W 36/0061; H04W 84/12

(57) ABSTRACT

Techniques for context aware connections to a wireless network are disclosed. An example of an apparatus for wireless communication includes a first interface configured to receive neighbor report information from one or more wireless nodes, a processing system configured to generate a beacon frame, generate a neighbor report based on the received neighbor report information, a second interface configured to output the beacon frame for transmission, and output the neighbor report as an unsolicited frame after outputting the beacon frame.

### CROSS-REFERENCE TO RELATED APPLICATIONS

This application claims the benefit of U.S. Provisional Application No. 62/252,551 filed Nov. 8, 2015, entitled “CONTEXT AWARE WIRELESS LOCAL AREA NETWORK CONNECTION,” the entire contents of which is hereby incorporated herein by reference.

### BACKGROUND

Aspects of the inventive subject matter generally relate to the field of wireless communication and, more particularly, to reducing the time and power required for Wireless Local Area Network (WLAN) scans with a client station.

WLAN systems are widely deployed to support wireless communication for client stations, which may be computers, cellular phones, etc. WLAN systems are deployed in various locations such as office buildings, coffee shops, malls, airport terminals, schools, and other hot spots where data usage is expected to be high. WLAN systems allow client stations to obtain data connectivity (e.g., to connect to the Internet) from virtually anywhere in the world. Many WLAN systems implement the Institute of Electrical and Electronics Engineers (IEEE) 802.11 standard to enable detection of Access Points (APs) within the WLAN. Some WLAN detection algorithms allow for roaming based on Received Signal Strength Indications (RSSI).

A client station may be configured to search for WLAN systems whenever the client station is powered on. The client station generally does have any context regarding its location or which APs are near its vicinity. Without such context, the initial WLAN scans performed by the client station may require an increased amount of time and may consume an increased amount of power (i.e., battery life).

### SUMMARY

An example of an apparatus for wireless communication according to the disclosure includes a first interface configured to receive neighbor report information from one or more wireless nodes, a processing system configured to, generate a beacon frame, generate a neighbor report based on the received neighbor report information, a second interface configured to output the beacon frame for transmission, and output the neighbor report for transmission after outputting the beacon frame.

Implementations of such an apparatus may include one or more of the following features. The processing system may be configured to generate an Access Network Query Protocol (ANQP) frame having the neighbor report included therein, and the second interface may be configured to output the ANQP frame for transmission independent of any request. The first interface may be configured to retrieve the neighbor report information from a remote server. The neighbor report may identify a time at which the apparatus last scanned for a wireless node. The neighbor report may include a signal strength value associated with each of one or more neighboring wireless nodes identified in the neighbor report.

An example a wireless node according to the disclosure includes a receiver configured to receive neighbor report information from one or more wireless nodes, a processing system configured to generate a beacon frame, generate a neighbor report based on the received neighbor report information, a transmitter configured to transmit the beacon frame, and transmit the neighbor report after transmitting the beacon frame.

An example of a method for wireless communication according to the disclosure includes receiving neighbor report information from one or more wireless nodes, generating a beacon frame, generating a neighbor report based on the received neighbor report information, outputting the beacon frame for transmission, and outputting the neighbor report after outputting the beacon frame.

Implementations of such a method may include one or more of the following features. Generating an Access Network Query Protocol (ANQP) frame having the neighbor report included therein, such that outputting the neighbor report may include outputting the ANQP frame for transmission independent of any request. Receiving the neighbor information may include retrieving the neighbor report from a remote server. The neighbor report may identify a time at which a wireless node was scanned. The neighbor report may include a signal strength value associated with each of one or more neighboring wireless nodes identified in the neighbor report.

An example of an apparatus for wireless communications according to the disclosure includes means for receiving neighbor report information from one or more wireless nodes, means for generating a beacon frame, means for generating a neighbor report based on the received neighbor report information, means for outputting the beacon frame for transmission, and means for outputting the neighbor report after outputting the beacon frame.

Implementations of such an apparatus may include one or more of the following features. The means for generating the neighbor report may include means for generating an Access Network Query Protocol (ANQP) frame having the neighbor report included therein, and the means for outputting the neighbor report may include means for outputting the ANQP frame for transmission independent of any request. The means for receiving the neighbor report information may include means for retrieving the neighbor report information from a remote server. The neighbor report may identify a time at which the apparatus last scanned for a wireless node. The neighbor report may include a signal strength value associated with each of one or more neighboring wireless nodes included in the neighbor report.

An example of a computer-readable medium storing computer-executable code according to the disclosure includes code to receive neighbor report information from one or more wireless nodes, generate a beacon frame, generate a neighbor report based on the received neighbor report information, output a first signal including the beacon frame, and output a second signal including the neighbor report after outputting the first signal.

An example of an apparatus for wireless communications according to the disclosure includes a first interface configured receive a neighbor report comprising one or more neighbor record elements, and a processing system configured to initiate an association process with at least one wireless node identified in the one or more neighbor record elements.

Implementations of such an apparatus may include one or more of the following features. At least one of the one or more neighbor record elements may identify a time at which the apparatus last scanned for a wireless node, and the processing system may be configured to initiate the association process based at least in part on the time. At least one of the one or more neighbor record elements may indicate a signal strength value, and the processing system configured to initiate the association process based at least in part on the signal strength value. The one or more neighbor record elements may include a plurality of fields, the processing system may be further configured to determine a first order for the one or more neighbor record elements based on at least one of the plurality of fields and initiate the association process based at least in part on the first order.

An example of a wireless node according to the disclosure includes a transceiver configured receive a neighbor report comprising one or more neighbor record elements, and a processing system operably coupled to the transceiver and configured to initiate an association process with at least one wireless node identified in the one or more neighbor record elements.

An example of a method for wireless communications according to the disclosure includes receiving a neighbor report comprising one or more neighbor record elements, and initiating an association process with at least one wireless node identified in the one or more neighbor record elements.

Implementations of such a method may include one or more of the following features. At least one of the one or more neighbor record elements may identify a time at which a wireless node was scanned, and initiating the association process with the at least one wireless node identified in the one or more neighbor record elements may be based at least in part on the on the time. At least one of the one or more neighbor record elements may indicate a signal strength value, and initiating the association process with the at least one wireless node identified in the one or more neighbor record elements is based at least in part on the signal strength value. The one or more neighbor record elements may include a plurality of fields and the method may further include determining a first order for the one or more neighbor record elements based on at least one of the plurality of fields, and initiating the association process with the at least one wireless node identified in the one or more neighbor record elements may be based at least in part on the first order.

An example of an apparatus for wireless communications according to the disclosure includes means for receiving a neighbor report comprising one or more neighbor record elements, and means for initiating an association process with at least one wireless node identified in the one or more neighbor record elements.

Implementations of such an apparatus may include one or more of the following features. At least one of the one or more neighbor record elements may identify a time at which the apparatus last scanned for a wireless node, and the means for initiating the association process may be based at least in part on the on the time. At least one of the one or more neighbor record elements may indicate a signal strength value, and the means for initiating the association process may be based at least in part on the signal strength value. The one or more neighbor record elements may include a plurality of fields and the apparatus may further include a means for determining a first order for the one or more neighbor record elements based on at least one of the plurality of fields, and the means for initiating the association process may be based at least in part on the first order.

An example of a computer-readable medium storing computer-executable code according to the disclosure includes code to receive a neighbor report comprising one or more neighbor record elements, and initiate an association process with at least one wireless node identified in the one or more neighbor record elements.

Items and/or techniques described herein may provide one or more of the following capabilities, as well as other capabilities not mentioned. An access point may generate a neighbor report. The neighbor report may be in the form of an unsolicited ANQP response frame and broadcast on a periodic basis. A client station may passively receive the neighbor report. The client station may initiate an associate process based on the neighbor report. The client station may join a network without performing a WLAN scan. An unattached client station may request a neighbor report from an access point. The time to join a network and the power consumed to discover access points may be reduced. Further, it may be possible for an effect noted above to be achieved by means other than that noted, and a noted item/technique may not necessarily yield the noted effect.

### BRIEF DESCRIPTION OF THE DRAWINGS

FIG. 1 is an example block diagram of a wireless local area network for context aware connection.

FIG. 2 is an example network diagram of a wireless local area communication network including a position server.

FIG. 3 is a system for compiling AP scan list information and generating neighbor reports.

FIG. 4A is a message flow diagram for the passive receipt of a neighbor report by a client station.

FIG. 4B is a message flow diagram of an active request for a neighbor report by a client station.

FIGS. 5A and 5B are examples ANQP neighbor report frames.

FIG. 6A is flow diagram of a process for broadcasting a neighbor report as an unsolicited ANQP response frame.

FIG. 6B is flow diagram of a process for initiating a client association process based on a received neighbor report.

FIG. 7 is flow diagram of a process for requesting a neighbor report and initiating a client association process.

FIG. 8A a block diagram of an electronic device for use in context aware connections in a WLAN.

FIG. 8B is a block diagram of an exemplary wireless node.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a method for wireless communication includes generating a neighbor report, generating a beacon frame, outputting the beacon frame for broadcast, and outputting the neighbor report as an unsolicited frame after outputting the beacon frame.

The description that follows includes exemplary systems, methods, techniques, instruction sequences, and computer program products that embody techniques of the present inventive subject matter. However, it is understood that the described aspects may be practiced without these specific details. For instance, although examples utilize Access Network Query Protocol Neighbor reports for providing context to a client station, aspects are not so limited. In other aspects, the neighbor report information may be provided by other wireless standards and devices (e.g., WiMAX devices). In other instances, well-known instruction instances, protocols, structures, and techniques have not been shown in detail in order not to obfuscate the description.

In wireless communication networks, reducing the need for a client station to perform a WLAN scan can be a desired feature for users since WLAN scans generally take time, require additional bandwidth, and utilize additional power. When a client station is initialized or relocated, it may be configured to perform a WLAN scan to determine the context of the current environment. Typically, the client station will scan all valid channels based on established standards (e.g., IEEE 802.11) in an effort to detect the Access Points (APs), or other peer interests, in the WLAN. The discovery of peers in the network may be utilized for ranging or other positioning techniques. The scan results may be analyzed based on signal strength (e.g., RSSI). WLAN scan results, however, often fail to detect all APs in an area because the dwell time on a given channel may not be sufficient. Increasing dwell times may improve the results, but at the cost of additional time and power usage. The time and energy used by a client station to scan the WLAN and build a context generally reduces the ability of the client station to perform other preferred processing tasks. While enhancements to reduce the total WLAN scan time are known, the context aware WLAN connections described herein may eliminate the need for a client station to perform a WLAN scan.

In an example, an AP may periodically scan its environment to build a neighbor report. The AP may periodically broadcast the neighbor report on their home channel. For example, the neighbor report may be broadcast after every beacon using an unsolicited Access Network Query Protocol (ANQP) response frame. The neighbor report may include signal and position information (e.g., Signal Strength value, Latitude value, Longitude value, Altitude, Z axis information, Civic location information) for each access point. In an aspect, the neighbor report may include information element to indicate the time the neighbor report was created (i.e., the time of the last scan to identify how recent or stale neighbor report information may be). This neighbor report broadcast allows a client station that receives the beacon to also receive the neighbor report. Since the neighbor report includes information about all of the APs in the vicinity, once it is received by the mobile station, the mobile station no longer would need to perform a full-scan to determine the context of the environment.

In an example, a client station may send a probe request to an AP, and upon receiving the response from the AP, the client station may send a neighbor report request using ANQP. The use of the probe request and response may reduce the wait time associated with passively detecting the AP beacons and the corresponding neighbor report.

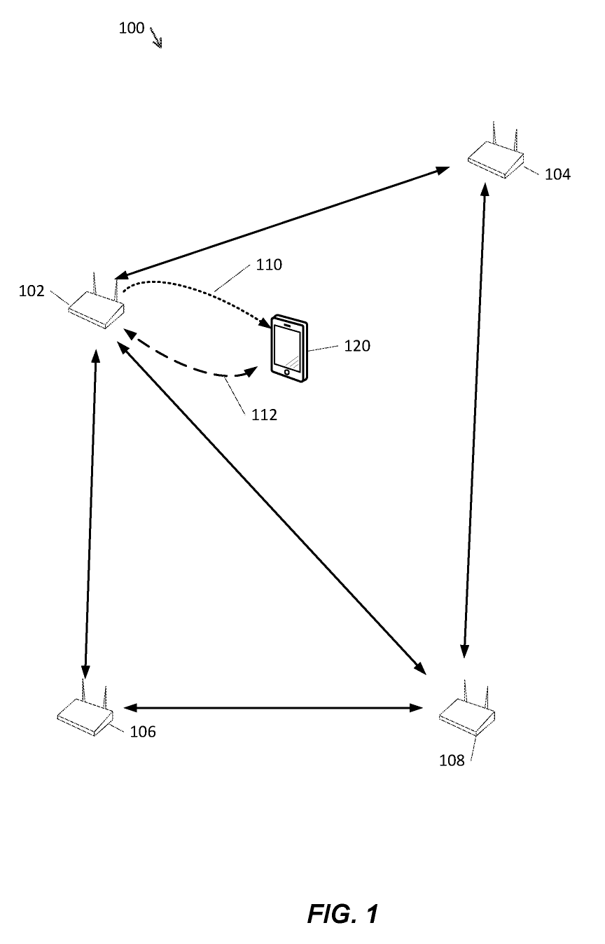

Referring to FIG. 1, an example block diagram of a wireless communication network 100 for enabling a context aware WLAN connection is shown. The wireless communication network 100 includes wireless communication nodes such as access points (AP) and access terminals (AT). For example, the communication network 100 includes four access points 102, 104, 106, 104 and a client station 120. The access points 102, 104, 106, 108 may be an advanced WLAN access points capable of determining their own positions (e.g., a self-locating access point). The access points may be configured to communicate with one or more other access points in the wireless communication network 100 (e.g., within the communication range of one another). For example, a first access point 102 may communicate with a second access point 104, a third access point 106, and a fourth access point 108. In some implementations, access points can be arranged that one access point can be designated as a master access point, and the other access points can be designated as target access points. Each of the access points 102, 104, 106, 108 may exchange signal and position information with one another over wireless channels. For example, the access points may exchange fine timing messages (FTM) with the other access points that are within communication range. Each of the access points may utilize the wireless communication exchanges to build respective neighbor reports. The client station 120 can be any suitable electronic device (e.g., a notebook computer, a tablet computer, a netbook, a mobile phone, a gaming console, a personal digital assistant (PDA), inventory tag, etc.) with WLAN communication capabilities. Furthermore, in FIG. 1, the client station 120 is within the communication range of one or more access points 102, 104, 106, 108.

The client station 120 may passively monitor network channels for periodic beacon broadcasts from the access points, and receive an ANQP response frame 110 from the first access point 102. In an aspect, the client station may initiate a probe request to initiate an ANQP exchange 112 with the first access point 102. The content of the ANQP response frame 110 may conform in part to network standards (e.g., IEEE 802.11, 8.4.5.12). The unsolicited ANQP response frame 110 may occur while the client station 120 is unattached from the first access point 102. For example, the ANQP response frame 110 may be received prior to a wireless client association process between the client station 120 and the first access point 102. In general, during the client association process, the Service Set Identification (SSID) Media Access Control (MAC) address, and security settings are sent from the client to the access point and are then checked by the access point. A client associate process may result in attaching the client station 120 to the first access point 102. In an aspect, an ANQP exchange 112 between the client station 120 and the first access point 102 may include an ANQP query request from the client station 120 to the first access point 102, an Acknowledgment (ACK) message from the first access point 102 to the client station 120, an ANQP query response from the first access point 102 to the client station 120, and an ACK message from the client station 120 to the first access point 102. Both the unsolicited ANQP response frame 110 and the ANQP query response (e.g., in the ANQP exchange 112) include a neighbor report containing positioning and signal information associated with the neighboring access points (e.g., 104, 106, 108). Upon receipt of the neighbor report, the client station 120 may be configured to connect to (e.g., associate with) one of the access points 102, 104, 106, 108 without performing a WLAN scan.

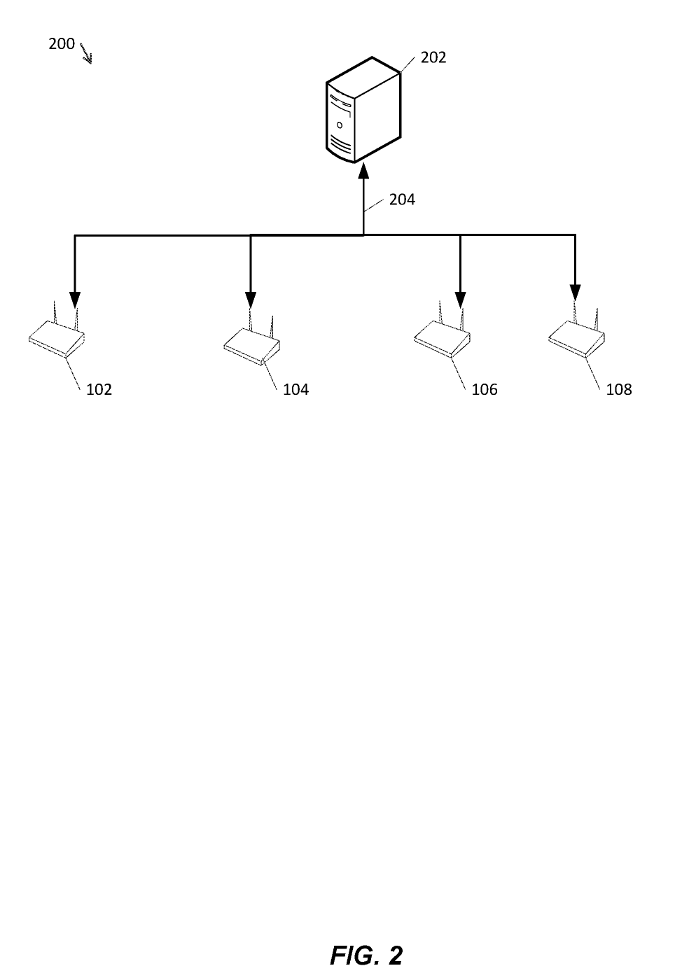

Referring to FIG. 2, an example network diagram of a wireless local area network 200 including a position server 202 is shown. The network 200 includes access points 102, 104, 106, 108, a position server 202, and a communication path 204. The position server 202 is a computing device including at least one processing system and a memory and is configured to execute computer executable instructions. For example, a position server 202 comprises a computer system including a processing system, non-transitory memory, disk drives, a display, a keyboard, a mouse. The processing system is preferably an intelligent device, e.g., a personal computer central processing unit (CPU), a microcontroller, an application specific integrated circuit (ASIC), etc. The memory includes random access memory (RAM) and read-only memory (ROM). The disk drives include a hard-disk drive, a CD-ROM drive, and/or a zip drive, and may include other forms of drives. The display is a liquid-crystal display (LCD) (e.g., a thin-film transistor (TFT) display), although other forms of displays are acceptable, e.g., a cathode-ray tube (CRT). The keyboard and mouse provide data input mechanisms for a user. The position server 202 stores (e.g., in the memory) processor-readable, processor-executable software code containing instructions for controlling the processing system to perform functions described herein. The functions may assist in the generation of neighbor reports for use in enabling context aware WLAN connections. The software can be loaded onto the memory by being downloaded via a network connection, uploaded from a disk, etc. Further, the software may not be directly executable, e.g., requiring compiling before execution. The access points 102, 104, 106, 108 are configured to communicate with the position server 202 to exchange position information via the communication path 204. The communication path 204 can be a wide area network (WAN) and can include the internet. The position server 202 can include a data structure (e.g., relational database, flat files) to store access point neighbor information. For example, the position server 202 can include access point position information (e.g., lat./long., x/y), RTT information, SIFS information, and other information associated with an access point (e.g., SSID, MAC address, uncertainty value, coverage area, etc.). An access point (e.g., 102, 104, 106, 108) may communicate with the position server 202 and can retrieve, for example, access point neighbor information, SIFS information and RTT information for use in client station positioning solutions. A configuration including the position server 202 as a remote server is exemplary only and not a limitation. In an aspect, the position server 202 may be connected directly to an access point, or the functionality may be included in an access point. More than one position servers may be used. The position server 202 can include one or more databases containing position information associated with other access points on additional networks. In an example, the position server 202 is comprised of multiple server units.

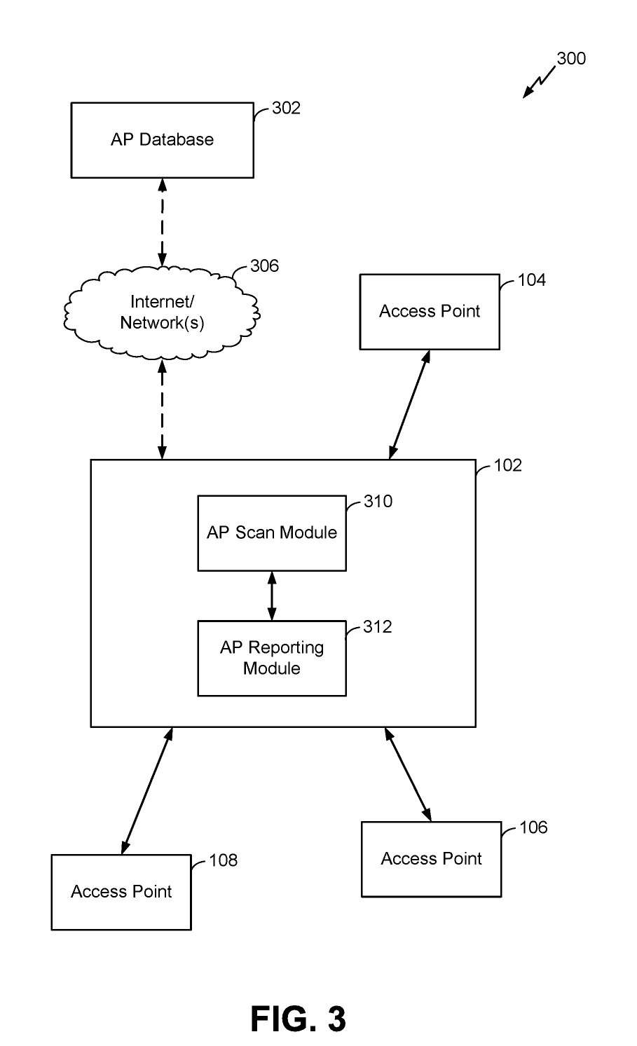

Referring next to FIG. 3, a system 300 for compiling AP scan list information and generating neighbor reports is shown. The system 300 may be included within an access point (e.g., the first access point 102). In an example, the structural and functional features of the system 300 may be based on a combination of an access point and the position server 202. For example, an AP database 302 may be a remote server such as the position server 202. The access points 102, 104, 106, 108 are the wireless transceivers in the network 100. Further, while FIG. 3 and the description herein refer specifically to a Wi-Fi communication network or other communication system having access points 102, 104, 106, 108, other transceivers, such as Bluetooth short-range wireless communication technology transceivers, femtocells, or the like, could be used in addition to, or in place of, the access points without departing from the scope of the description.

An AP scan module 310, which may be an interface including a wireless transceiver in the first access point 102, or a specialized unit, is configured to perform scans of access points and other peer stations within range of the access point. In response to this scan, the AP scan module 310 receives information from the access points in the network 100 and/or other devices. In an example, the AP scan module 310 is configured to create a neighbor report based on the scan information. The AP scan module 310 may also be configured to generate neighbor reports based on other exchanges between the access points, such as FTM or other protocol enabled data exchanges. An AP reporting module 312 is utilized to provide the received information from the access points to one or more data sources. For example, the AP reporting module 312 may provide access point information over the Internet or one or more networks 306 to a network-based AP database 302. While the AP database 302 is illustrated as a network entity remote from the access point 102, the AP database 302 and/or some or all of its functionality could alternatively be implemented at the access point 102, e.g., via a processing system and memory.

The AP database 302 compiles access point information from one or more access points in the form of network scan lists (e.g., Wi-Fi scan lists, Bluetooth short-range wireless communication technology scan lists, cellular scan lists, etc.) or other suitable formats to generate neighbor reports. Other implementations of the AP database 302 are also possible.

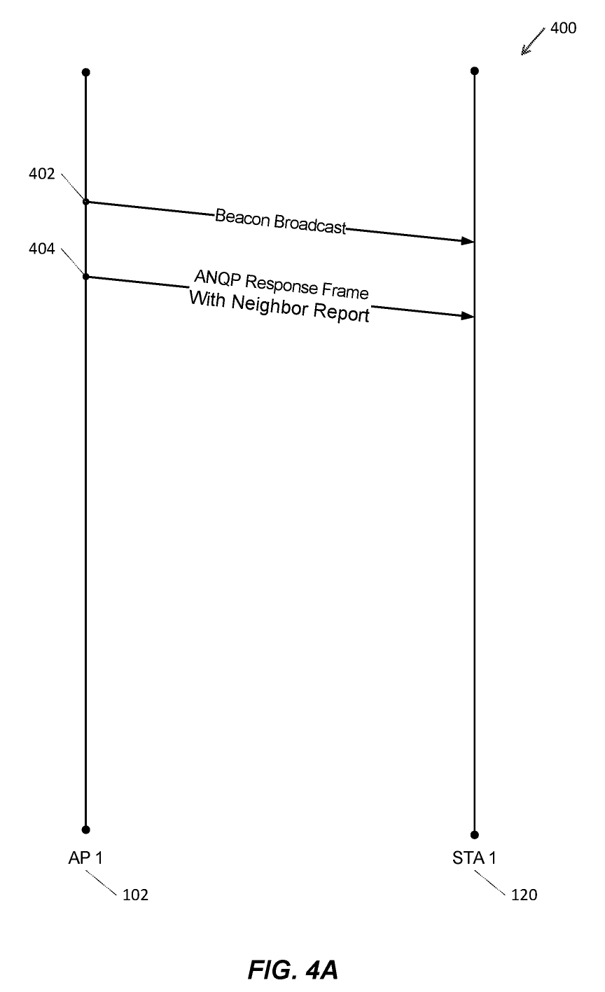

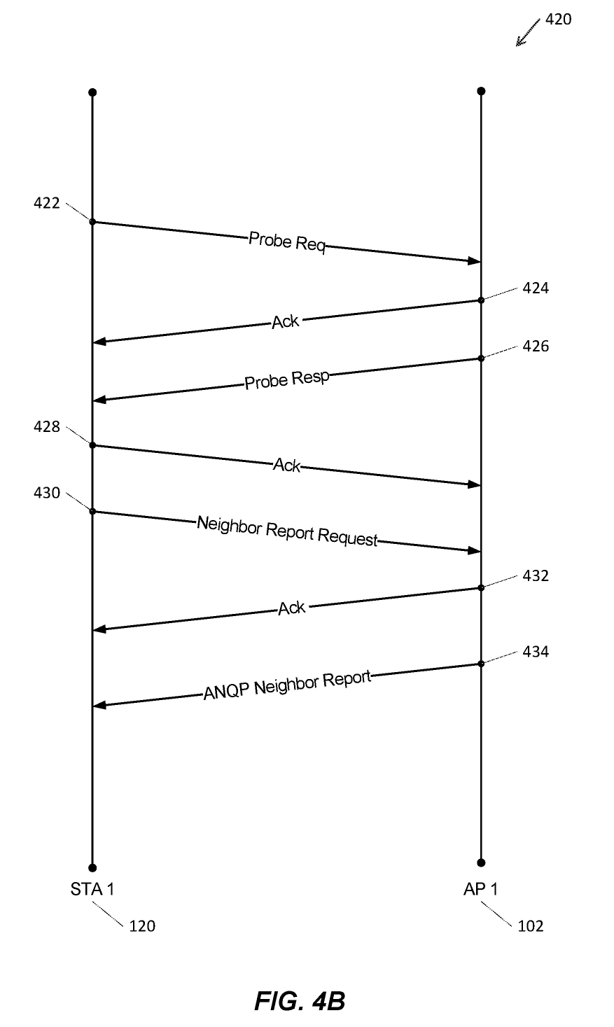

Referring to FIG. 4A, a message flow diagram 400 for the passive receipt of a neighbor report by a client station is shown. The message flow diagram 400 is based on the elements of the wireless communication network 100, and includes the first access point 102 and a client station 120. In an aspect, the client station 120 may passively monitor network channels for periodic beacon broadcasts 402 from the first access point 102. The beacon broadcasts typically occur every 110 ms per channel (excluding DFS channels). Within a specific network, the access points may be parked on common home channels based on accepted protocols (e.g., CH6 for 2.4G, and CH36 for 5G networks). After the broadcasting the beacon, the first access point 102 is configured to broadcast an ANQP Response Frame with a neighbor report 404 on the home channel. Once the neighbor report is received by the client station 120, the client station 120 may attempt to associated with (e.g., connect to) one or more of the access points included in the neighbor report without performing a WLAN scan. Use of the first access point 102 in FIG. 4A is exemplary only and not a limitation as other access points in the network 100 may provide the illustrated beacon and ANQP broadcasts.

Referring to FIG. 4B, a message flow diagram 420 of an active request of a neighbor report by a client station is shown. The message flow diagram 420 is based on the elements of the wireless communication network 100, and includes the first access point 102 and a client station 120. In an aspect, the client station 120 may transmit a probe request message 422 to the network 100. One or more of the access points may respond to the probe request message 422 by sending an acknowledgement. For example, the first access point 102 is configured to provide an acknowledgement 424. The first access point 102 may be configured to provide a probe response message 426 to the client station 120. The client station may send an acknowledgement 428 and then send a neighbor report request message 430 using ANQP. The first access point 102 may acknowledge the request (e.g., acknowledgement 432), and then send an ANQP neighbor report 434. The use of the probe request may decrease the time required to obtain the neighbor list as compared to passively waiting for a broadcasted neighbor report (e.g., as described in FIG. 4A). As previously described, once the neighbor report is received by the client station 120, the client station 120 may attempt to associated with (e.g., connect to) one or more of the access points included in the neighbor report without performing a WLAN scan. Use of the first access point 102 in FIG. 4B is also exemplary only and not a limitation as other access points in the network 100 may respond to the probe request message 422 and provide a respective ANQP neighbor report message.

The ANQP Response Frame with a neighbor report 404 and the ANQP neighbor report 434 may include a number of frames such as generally described in the industry standard protocols (e.g., IEEE 802.11). The frames, and associated fields, include information about the neighboring access points (e.g., 102, 104, 106, 108). The first access point 102, for example, is configured to parse the received frames and store the respective information (i.e., fields) in the frames. For example, the first access point 102 may include locally stored history files and almanac data, or may be operably connected to an AP database 302.

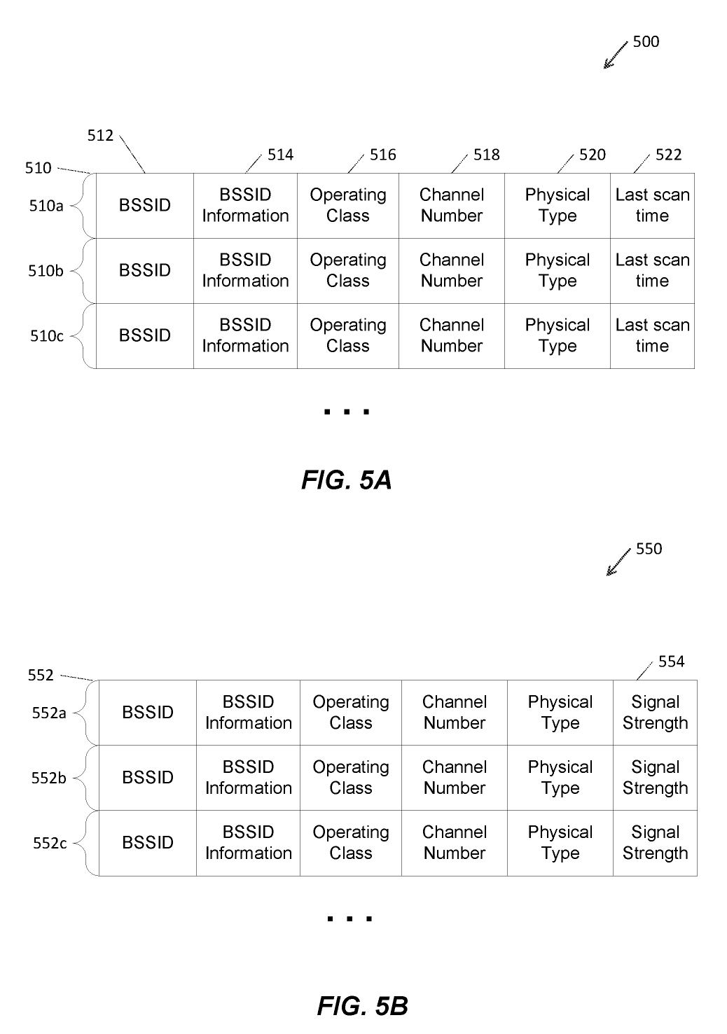

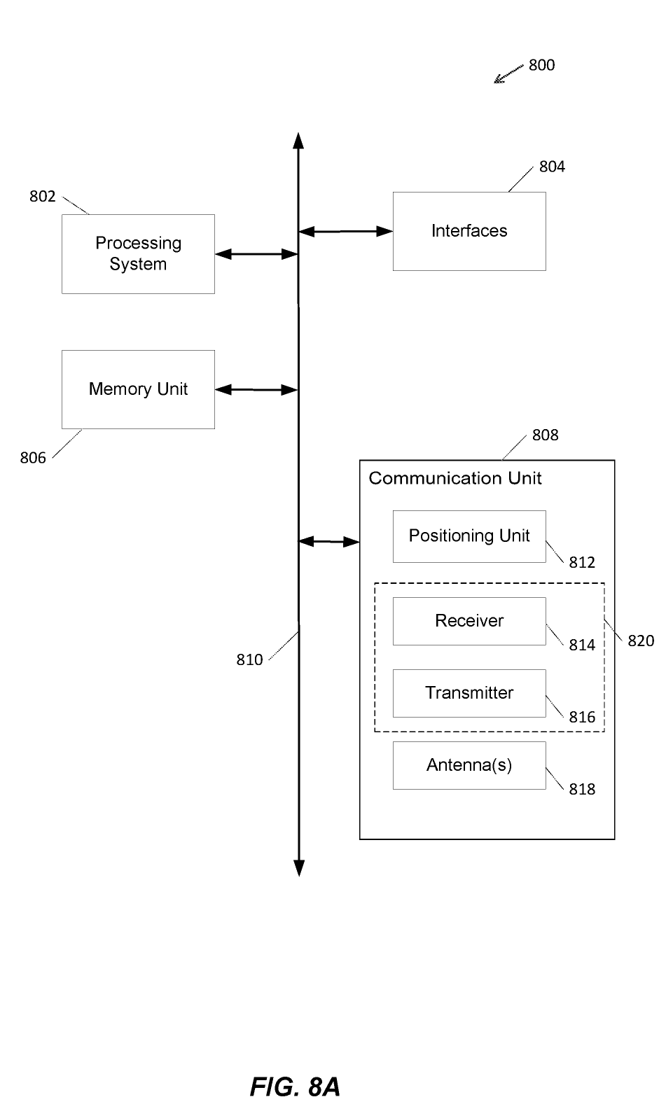

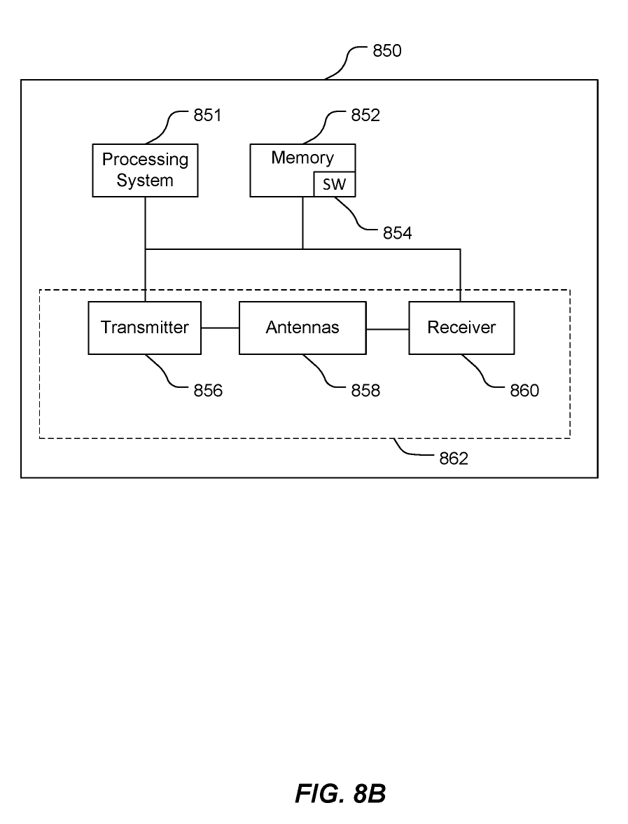

Referring to FIGS. 5A and 5B, with further reference to FIGS. 4A and 4B, examples of ANQP neighbor report frames are shown. A neighbor report frame with a last scan time 500 may be a MAC frame format such as generally described in the IEEE P802.11 standard, FIG. 8-255. The neighbor report frame with a last scan time 500 may be included in the ANQP Response Frame with a neighbor report 404 and the ANQP neighbor report 434, and thus is provided to the client station 120. The neighbor report frame with a last scan time 500 may include multiple neighbor record elements 510 (e.g., 510a, 510b, 510c), with each of the multiple neighbor record elements containing information associated with a neighboring access point. The values of the neighbor record elements may be used to determine which access point the client station 120 will attempt to connect to. The neighbor record element may contain position information (e.g., latitude, longitude, altitude) for each of the neighbors. In an aspect, the neighbor report frame with a last scan time 500 may be constrained to only include a sufficient list of neighboring stations to perform positioning and/or ranging. The content of the neighbor report may be influenced by both the spatial and frequency domain factors (e.g., in dual frequency band networks). The neighbor report may include the neighboring stations which have a signal strength value above a predetermined threshold, or may include only a fixed number of neighboring stations (e.g., the stations with the highest signal strength). The access points on the neighbor report may be constrained based on an estimated location of the client station (e.g., based on a range from the estimated location). Other constraints to the number or selection of the neighboring stations may also be used. For example, the neighbor list may be constrained based on subscription information (e.g., preferred vendors), or based on current network/station load. Other fields may also be used to determine which neighboring stations to include as a neighboring station. Exemplary neighbor record elements 510 may include a Basic Service Set Identification (BSSID) field 512, a BSSID Information field 514, an operating class field 516, a channel number field 518, a physical type field 520, and a last scan time field 522. Other sub-element fields may also be included. The BSSID field 512 represents the BSSID of the BSS being reported. The BSSID Information field 514 may be used to determine neighbor service set transition candidates. The operating class field 516 may be used to indicate operational frequency ranges (e.g., 2.4 GHz, 5 GHz), as well as channel spacing. The channel number field 518 may be used to provide channel center frequency information. The physical type field 520 indicates the PHY type of the access point indicted by the BSSID (e.g., ODFM, HT, DMG). The last scan time field 522 indicates the time at which the respective wireless node (e.g., access point) was scanned (e.g., responded to a probe request). The last scan time field 522 may provide a basis for identifying how recent or how stale the neighbor report information may be. The last scan time value may also be used to determine an order in which the client station 120 may attempt to connect to the respective access point (i.e., fresh scan times may take priority over stale scan times).

Referring to FIG. 5B, a neighbor report frame with a signal strength field 550 includes neighbor record elements 552 (e.g., 552a, 552b, 552c). The neighbor record elements 552 may include fields such as described above with respect to the neighbor report frame with a last scan time 500, in addition to a signal strength field 554. The signal strength field 554 may represent the Received Signal Strength (RSS) between the respective access points. The implementation of RSS measurements may differ based on the hardware configuration of the access points. In an example, the signal strength of a Broadcast Control Channel (BCCH) may be monitored and recorded. If the client station 120 receives a ANQP Response Frame with a neighbor report 404 or a ANQP neighbor report 434 from the first access point 102, then the signal strength field 554 may represent the signal strength received by the first access point 102 from the signals transmitted by the neighboring access points (e.g., 014, 106, 108). In this way, the client station 120 may use the signal strength field 554 to prioritize the attempts to associate with (e.g., connect to) the respective access points (i.e., attempt to connect to the strongest signals first). The signal strength field 554 may be included in the neighbor record elements with or without the last scan time field 522. Other fields may also be included.

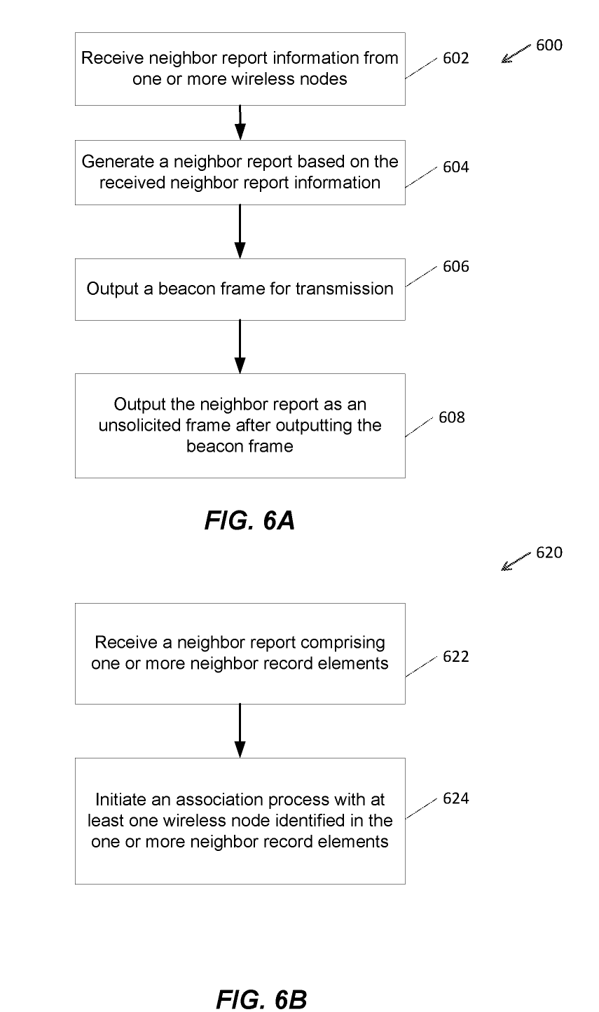

In operation, referring to FIG. 6A, a process 600 for broadcasting a neighbor report as an unsolicited ANQP response frame includes the stages shown. The process 600, however, is exemplary only and not limiting. The process 600 may be altered, e.g., by having stages added, removed, or rearranged.

At stage 602, the first access point 102 receives neighbor report information from one or more wireless nodes. The AP scan module 310 may detect other wireless transceivers in the network. For example, the first access point 102 may conduct a scan and detect the presence of other access points in the network 100 (e.g., access points 104, 106, 108). In an example, the first access point 102 may include, or be operably connected to one or more databases to store the neighbor report information. The data in the AP database 302 may be populated by a wireless network vendor, or may be provided and periodically updated by network resources. In an example, the first access point 102 may be configured to listen to beacon reports from the neighboring access points and store the appropriate fields (e.g., BSSID, location information, signal strength, etc.) The first access point 102 may be configured to store the neighbor report information locally or on the AP database 302. In an example, the first access point 102 may send probe requests to the neighboring access points and then store the information contained in the subsequent responses to the probe requests.

At stage 604, the first access point 102 generates a neighbor report based on the received neighbor report information. The AP scan module 310 is configured to parse the information in a signal received from the other access point at stage 602 to generate a neighbor report. The neighbor report may include the fields and data contained in the neighbor record elements 510, 552, as well as other information that may be used for a client association process.

In an aspect, the first access point 102 generates a neighbor report (i.e., locally), or the neighbor report may be generated on the AP database 302 (i.e., remotely). In an example, the first access point 102 may order the list of neighbors by creating an index value associated with each neighbor record element. The order (e.g., index, priority) of the neighbor record elements may be used by the client station 120 to determine an order in which to attempt a connection (e.g., a client association process). Other prioritization (i.e., ordering) requirements may also be used. The order of the neighbor list may be based on a signal strength, channel number, or physical type of the received request. The neighbor list may be constrained to include a subset of the neighborhood. For example, only 8 neighbors of a possible 14 neighbors are included in the neighbor report. In an example, the neighbor list is neither ordered nor constrained.

At stage 606, the first access point 102 generates a beacon frame and outputs the beacon frame for transmission. The beacon frame may be a signal including a MAC header, a frame body and a frame check sequence (e.g., an error detecting code). Additional fields in the beacon frame may include a timestamp, a beacon interval value, SSID value, capability information and other fields as defined by protocol standards (e.g., IEEE 802.11). The beacon interval value provides the interval value for neighbor report broadcast at stage 606.

At stage 608, the first access point 102 outputs the neighbor report as an unsolicited frame after outputting the beacon frame. In an example, the first access point 102 is configured to broadcast the neighbor report as an unsolicited ANQP frame after every beacon broadcast. The ANQP frame may be output for transmission independent of any request. For example, the unsolicited ANQP frame including the neighbor report may be provided in a signal to an unattached client station 120 (e.g., prior to establishing an association between the first access point 102 and the client station 120). The first access point 102 may provide the neighbor report as an IBSS under the (IEEE) 802.11 specifications. The order of the neighbor record elements in the neighbor report may be used by the client station 120 to determine a sequence of connection attempts. The receipt of the neighbor report enables the client device to attempt to connect to an access point without the need to perform a prior WLAN scan.

In operation, referring to FIG. 6B, a process 620 for initiating a client association process based on a received neighbor report includes the stages shown. The process 620, however, is exemplary only and not limiting. The process 620 may be altered, e.g., by having stages added, removed, or rearranged.

At stage 622, the client station 120 receives a neighbor report comprising one or more neighbor record elements. For example, the client station 120 is configured to receive an ANQP neighbor report comprising one or more neighbor record elements. The neighbor report may be received from a WLAN access point as an unsolicited ANQP frame after every beacon broadcast. For example, the first access point 102 may provide the neighbor report as an IBSS under the (IEEE) 802.11 specifications. The neighbor report may include the fields and data contained in the neighbor record elements 510, 552, as well as other information that may be used for a client association process. In an example, the client station 120 may be configured to order the list of neighbors by creating an index value associated with each neighbor record element. The order (e.g., index, priority) of the neighbor record elements may be used by the client station 120 to determine an order in which to attempt a connection (e.g., a client association process). Other prioritization (i.e., ordering) requirements may also be used. The order of the neighbor list may be based on a signal strength, channel number, or physical type of the received request.

At stage 624, the client station 120 is configured to initiate an association process with at least one wireless node identified in the one or more neighbor record elements. The client station 120 may utilize the neighbor report to attempt to connect to an access point without performing a prior WLAN scan. For example, the client station 120 may utilize the last scan time and/or the signal strength information (e.g., RTT, RSS) to determine which access point to initiate a client association process with (e.g., the most current, the strongest signal, the closest). During the client association process, the client station 120 attempts to enter the WLAN via an access point. Network parameters, such as a Service Set Identification (SSID), Media Access Control (MAC) address, and security settings may be sent from the client station 120 to the access point and are then checked by the access point. A client associate process may result in attaching the client station 120 to the first access point 102. If an attempt to attach to the first access point 102 fails, the client station 120 may be configured to initiate the association process with another access point included in the neighbor report. That is, the order of the neighbor record elements in the neighbor report, or values of the individual neighbor record elements, may be used by the client station 120 to determine a sequence of connection attempts.

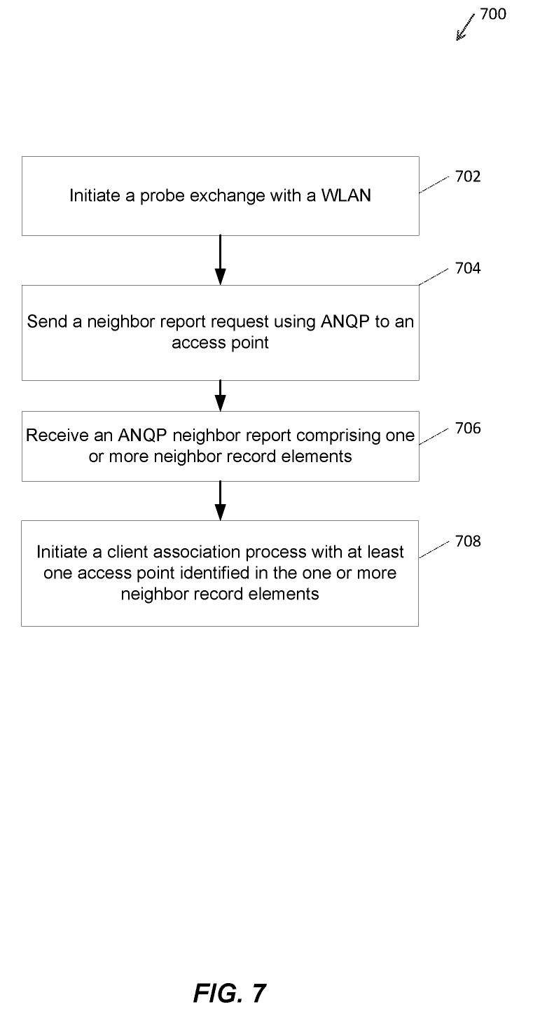

In operation, referring to FIG. 7, a process 700 for requesting a neighbor report and initiating a client association process includes the stages shown. The process 700, however, is exemplary only and not limiting. The process 700 may be altered, e.g., by having stages added, removed, or rearranged.

At stage 702, the client station 120 is configured to initiate a probe exchange with a WLAN. The client station 120 sends a probe request message 422 to discover nearby network (e.g., 802.11 compatible networks). The probe request may indicate a supported data rate. All access points receiving the probe request may respond (assuming they can support the data rate), and may provide information such as the access point SSID, data rates, encryption, and other parameters established in the network protocol.

At stage 704, the client station 120 is configured to send a neighbor report request using ANQP to an access point. In response to the probe exchange the client station 120 may choose a compatible access point (e.g., the first access point 102) based on a particular probe response message 426. The client station 120 is configured to send the neighbor report request using ANQP before attempting to associate with the first access point 102. That is, the probe exchange performed at stage 702 is used to provide basic context to the client station 120.

At stage 706, the client station 120 is configured to receive an ANQP neighbor report comprising one or more neighbor record elements. The neighbor report request and the subsequent ANQP neighbor report are sent and received by the client station 120 before attachment (e.g., connection to an access point). For example, the ANQP neighbor report is provided to the client station 120 prior to forming an association between the first access point 102 and the client station 120. In an example, a neighbor report includes one or more neighbor record elements 510, 552 and each record element includes location information associated with an access point. The client station 120 is configured to parse the frames within the neighbor record elements to determine a list of neighboring access points that may be used for positioning. For example, the neighbor report may indicate that a second access point, a third access point, and a fourth access point (e.g., access points 104, 106, 108 respectively) that should be within range of the client station 120. The order of the list of access points in the neighbor report may indicate to the client station 120 the order in which to attempt association with (e.g., connection to) respective access points. In an example, a field within the neighbor report may indicate order of attempted association (e.g., last scan time, signal strength). The record elements may also include RTT and RSS information for the neighbors and the client station 120 may be configured to initiate the client association process based at least in part on the RTT and RSS information.

At stage 708, the client station 120 is configured to initiate a client association process with at least one access point identified in the one or more neighbor record elements. The client station 120 may remain unattached throughout the proceeding stages of the process 700. The client station 120 may utilize the neighbor report to attempt to connect to an access point without performing a prior WLAN scan. During the client association process, the client station 120 attempts to enter the WLAN via an access point. Network parameters, such as a Service Set Identification (SSID), Media Access Control (MAC) address, and security settings may be sent from the client station 120 to the access point and are then checked by the access point. A client associate process may result in attaching the client station 120 to the first access point 102. If an attempt to attach to the first access point 102 fails, the client station 120 may be configured to initiate the association process with another access point included in the neighbor report. That is, the order of the neighbor record elements in the neighbor report, or values of the individual neighbor record elements, may be used by the client station 120 to determine a sequence of connection attempts.

Aspects may take the form of an entirely hardware aspect, an entirely software aspect (including firmware, resident software, micro-code, etc.) or an aspect combining software and hardware aspects that may all generally be referred to herein as an “apparatus,” “circuit,” “module,” “interface,” or “system.” Furthermore, aspects of the inventive subject matter may take the form of a computer program product embodied in any tangible medium of expression having computer usable program code embodied in the medium. The described aspects may be provided as a computer program product, or software, that may include a machine-readable medium having stored thereon instructions, which may be used to program a computer system (or other electronic device(s)) to execute (e.g., perform) a process according to aspects, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a non-transitory processor-readable storage medium, a machine-readable storage medium, or a machine-readable signal medium (e.g., a computer-readable medium storing computer-executable code). A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable signal medium may be transmitted using any suitable medium, including, but not limited to, wireline, wireless, optical fiber cable, RF, or other communications medium.

Computer program code for carrying out operations of the aspects may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

Referring to FIG. 8A is a block diagram of one aspect of an electronic device 800 for use in context aware connections in a WLAN. In some implementations, the electronic device 800 may be a client station 120 embodied in a device such as a notebook computer, a tablet computer, a netbook, a mobile phone, a smart phone, a gaming console, a personal digital assistant (PDA), or an inventory tag. The electronic device 800 may be other electronic systems such as a Home Node B (HNB) device with a wireless transceiver and positioning capabilities (e.g., a type of access point). The electronic device 800 includes a processing system 802 (possibly including multiple processors, multiple cores, multiple nodes, and/or implementing multi-threading, etc.). The electronic device 800 includes a memory unit 806. The memory unit 806 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 800 also includes a bus 810 (e.g., PCI, ISA, PCI-Express, HyperTransport®, InfiniBand®, NuBus, AHB, AXI, etc.), and interfaces 804 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, etc.).

The electronic device 800 also includes a communication unit 808. The communication unit 808 comprises a positioning unit 812, a receiver 814, a transmitter 816, and one or more antennas 818. The transmitter 816, the antennas 818, and the receiver 814 form a wireless communication module (with the transmitter 816 and the receiver 814 being a transceiver 820). The transmitter 816 and the receiver 814 are configured to communicate bi-directionally with one or more client stations and other access points via a corresponding antenna 818. In an example, the receiver 814 may be a first interface (e.g., for receiving data) and the transmitter 816 may be a second interface (e.g., for outputting data). In some aspects, the electronic device 800 can be configured as a WLAN station with positioning determining capabilities (e.g., a type of access point). The positioning unit 812 can utilize the FTM session information exchanged with the access points to determine RSS and/or TDOA timing information associated with the access points. The positioning unit 812 can determine the position of the electronic device 800 based, at least in part, on TDOA timing information, and AP position information. In some aspects, the access points 102, 104, 106, 108 can also be configured as the electronic device 800 of FIG. 8A. In this aspect, the access points can use their processing capabilities to execute their respective operations described above. Any one of these functionalities may be partially (or entirely) implemented in hardware and/or on the processing system 802. For example, the functionality may be implemented with an application specific integrated circuit, in logic implemented in the processing system 802, in a co-processor on a peripheral device or card, etc. Further, realizations may include fewer or additional components not illustrated in FIG. 8A (e.g., display screen, video cards, audio cards, additional network interfaces, peripheral devices, etc.). The processing system 802, the memory unit 806, and the interfaces 804 are coupled to the bus 810. Although illustrated as being coupled to the bus 810, the memory unit 806 may be coupled to the processing system 802.

When the electronic device 800 is implemented or used as a transmitting node, the processing system 802 may be configured to select one of a plurality of media access control (MAC) header types, and to generate a packet having that MAC header type. For example, the processing system 802 may be configured to generate a packet comprising a MAC header and a payload and to determine what type of MAC header to use.

When the electronic device 800 is implemented or used as a receiving node, the processing system 802 may be configured to process packets of a plurality of different MAC header types. For example, the processing system 802 may be configured to determine the type of MAC header used in a packet and process the packet and/or fields of the MAC header.

Referring to FIG. 8B, an example of a wireless node such as an access point 850 comprises a computer system including a processing system 851, memory 852 including software 854, a transmitter 856, antennas 858, and a receiver 860. The access points 102, 104, 106, 108 may be configured as the access point 850 of FIG. 8B. The transmitter 856, antennas 858, and the receiver 860 form a wireless communication module (with the transmitter 856 and the receiver 860 being a transceiver 862). The transmitter 856 is connected to one of the antennas 858 and the receiver 860 is connected to another of the antennas 858. Other example access points may have different configurations, e.g., with only one antenna 858, and/or with multiple transmitters 856 and/or multiple receivers 860. The transmitter 856 and the receiver 860 are configured such that the access point 850 can communicate bi-directionally with the client station 120 via the antennas 858. The processing system 851 is preferably an intelligent hardware device, e.g., a central processing unit (CPU), a microcontroller, an application specific integrated circuit (ASIC), etc. The processing system 851 could comprise multiple separate physical entities that can be distributed in the access point 850. The memory 852 includes random access memory (RAM) and read-only memory (ROM). The memory 852 is a processor-readable storage medium that stores the software 854 which is processor-readable, processor-executable software code containing processor-readable instructions that are configured to, when executed, cause the processing system 851 to perform various functions described herein (although the description may refer only to the processing system 851 performing the functions). Alternatively, the software 854 may not be directly executable by the processing system 851 but configured to cause the processing system 851, e.g., when compiled and executed, to perform the functions.

In addition, the components and functions represented by FIGS. 8A and 8B as well as other components and functions described herein, may be implemented using any suitable means. Such means are implemented, at least in part, using corresponding structure as taught herein. Thus, one or more of such means is implemented using one or more of processing systems, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the processes 600, 620, and 700 illustrated in FIGS. 6A, 6B and 7, respectively, may correspond at least in some aspects, to corresponding blocks of the electronic device 800 and the access point 850. For example, a means for initiating comprises the processing system 802, the communication unit 808, or both. A means for generating comprises the processing system 802. A means for outputting comprises the interfaces 804, the communication unit, or both. A means for retrieving comprises the interfaces 804, the communication unit 808, or both. A means for receiving comprises the interfaces 804, the communication unit 808, or both. A means for determining comprises the processing system 802.

While the aspects are described with reference to various implementations and exploitations, it will be understood that these aspects are illustrative and that the scope of the inventive subject matter is not limited to them. In general, techniques for positioning with access network query protocol neighbor reports as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

As used herein, including in the claims, unless otherwise stated, a statement that a function or operation is “based on” an item or condition means that the function or operation is based on the stated item or condition and may be based on one or more items and/or conditions in addition to the stated item or condition.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may comprise one or more elements. In addition, terminology of the form “at least one of a, b, or c” or “one or more of a, b, or c” used in the description or the claims means “a or b or c or any combination of these elements.” For example, this terminology may include a, or b, or c, or a and b, or a and c, or a and b and c, or 2a, or 2b, or 2c, or 2a and b, and so on.

Further, more than one invention may be disclosed.

1. An apparatus for wireless communication, comprising:
a first interface configured to receive neighbor report information from one or more wireless nodes;
a processing system configured to:
generate a beacon frame;
generate a neighbor report based on the received neighbor report information;
a second interface configured to:
output the beacon frame for transmission; and
output the neighbor report for transmission after outputting the beacon frame.

2. The apparatus of claim 1 wherein the processing system is configured to generate an Access Network Query Protocol (ANQP) frame having the neighbor report included therein, and the second interface is configured to output the ANQP frame for transmission independent of any request.

3. The apparatus of claim 1 wherein the first interface is configured to retrieve the neighbor report information from a remote server.

4. The apparatus of claim 1 wherein the neighbor report identifies a time at which the apparatus last scanned for a wireless node.

5. The apparatus of claim 1 wherein the neighbor report includes a signal strength value associated with each of one or more neighboring wireless nodes identified in the neighbor report.

6. A wireless node, comprising:
a receiver configured to receive neighbor report information from one or more wireless nodes;
a processing system configured to:
generate a beacon frame;
generate a neighbor report based on the received neighbor report information;
a transmitter configured to:
transmit the beacon frame; and
transmit the neighbor report after transmitting the beacon frame.

7.-17. (canceled)

18. An apparatus for wireless communications, comprising:
a first interface configured receive a neighbor report comprising one or more neighbor record elements; and
a processing system configured to initiate an association process with at least one wireless node identified in the one or more neighbor record elements.

19. The apparatus claim 18 wherein at least one of the one or more neighbor record elements identifies a time at which the apparatus last scanned for a wireless node, and the processing system is configured to initiate the association process based at least in part on the time.

20. The apparatus of claim 18 wherein at least one of the one or more neighbor record elements indicates signal strength value, and the processing system configured to initiate the association process based at least in part on the signal strength value.

21. The apparatus of claim 18 wherein the one or more neighbor record elements include a plurality of fields, the processing system is further configured to determine a first order for the one or more neighbor record elements based on at least one of the plurality of fields and initiate the association process based at least in part on the first order.

22.-31. (canceled)
